(19) United States
(12) Patent Application Publication
(10) Pub. No.: US 2018/0143457 A1
(43) Pub. Date: May 24, 2018

(54) Magnetically Mounted Connector for Adhesion of a Pair of Auxiliary Eyeglasses

(71) Applicant: Wen-Tse Huang, Kaohsiung City (TW)

(72) Inventor: Wen-Tse Huang, Kaohsiung City (TW)

(21) Appl. No.: 15/358,169

(22) Filed: Nov. 22, 2016

(51) Int. Cl. G02C 9/04; G02C 7/08

(52) U.S. Cl. CPC G02C 9/04; G02C 2200/14; G02C 2200/02; G02C 7/086

(57) ABSTRACT

A magnetically mounted connector is used to join a spectacles frame and a temple of a pair of eyeglasses. The spectacles frame has a mounting portion at each lateral end thereof. The magnetically mounted connector includes a connector body, a magnetic holder, and a magnet held in the magnetic holder. The connector body has one end to which the mounting portion of the spectacles frame is connected. The magnetic holder is extended outward from the connector body. When the magnetically mounted connector joins the spectacles frame and the temple, the magnet is situated at an inner side of the mounting portion of the spectacles frame for adhesion of a pair of auxiliary eyeglasses to the pair of eyeglasses.

### BACKGROUND OF THE INVENTION

### 1. Field of the Invention

The present invention relates to a magnetically mounted connector for adhesion of a pair of auxiliary eyeglasses and, more particularly, to a magnetically mounted connector by which a pair of auxiliary eyeglasses can be adhered to a pair of slim-frame eyeglasses.

### 2. Description of the Related Art

The so-called front-hanging eyeglasses structure includes a pair of main eyeglasses and a pair of auxiliary eyeglasses, which features functional lenses as sunglasses or polarizers mostly. A user staying outside and dazzled by fierce sunlight could hang the pair of auxiliary eyeglasses in front of the pair of main eyeglasses to filter excessive sunlight without wearing another pair of main eyeglasses. As compact and light accessories, a pair of auxiliary eyeglasses is easily carried and worn.

A conventional front-hanging eyeglasses structure is usually provided with magnets that are installed on a spectacles frame of a pair of main eyeglasses as well as a spectacles frame of a pair of auxiliary eyeglasses for development of mutual magnetic attraction through which the pair of auxiliary eyeglasses and the pair of main eyeglasses are assembled or disassembled. However, magnets embedded in the spectacles frame of the pair of main eyeglasses is replaced inconveniently. Additionally, a pair of conventional front-hanging eyeglasses is structurally inapplicable to a pair of slim-frame eyeglasses. Specifically, a spectacles frame and a temple of a pair of slim-frame eyeglasses are made of metal laminates in general and not constructed as a good carrier in which any magnet is embedded. Furthermore, a spectacles frame and a temple in a pair of slim-frame eyeglasses usually join together through a laminate connector in which a magnet is embedded difficultly.

### BRIEF SUMMARY OF THE INVENTION

Thus, an objective of the present invention is to provide a magnetically mounted connector which is adapted for joining a spectacles frame and a temple of a pair of slim-frame eyeglasses, so that a pair of auxiliary eyeglasses can be hung on the pair of slim-frame eyeglasses and a magnet malfunctioned is replaced easily.

To achieve this and other objectives, a magnetically mounted connector of the present invention includes a connector body, a magnetic holder, and a magnet. The connector body is adapted for joining a spectacles frame and a temple of a pair of eyeglasses. The spectacles frame has a mounting portion at each of two lateral ends thereof. The magnetic holder is extended outward from the connector body. The magnet is held in the magnetic holder for combination of a pair of auxiliary eyeglasses to the pair of eyeglasses.

The magnetically mounted connector of the present invention is effective in not only joining a spectacles frame and a temple in a pair of slim-frame eyeglasses but also replacing connectors common in a pair of conventional slim-frame eyeglasses for adhesion of a pair of auxiliary eyeglasses to the pair of conventional slim-frame eyeglasses.

In an embodiment, the magnetic holder is situated at an inner side of the mounting portion of the spectacles frame to which the connector body is connected.

In an embodiment, the connector body includes a first end and a second end opposed to the first end. The first end of the connector body is adapted to be connected to the mounting portion of the spectacles frame. The magnetic holder is extended outward from the first end or the second end of the connector body and is in the form of a collar. A cavity is formed in the magnetic holder, and an opening is provided in a top of the magnetic holder to allow the magnet to be placed in the cavity from the opening of the magnetic holder.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 is a schematic view illustrating a spectacles frame of a pair of slim-frame eyeglasses and a magnetically mounted connector according to an embodiment of the present invention.

FIG. 2 is an exploded view of the magnetically mounted connector in FIG. 1.

FIG. 3 is a schematic view illustrating the magnetically mounted connector in FIG. 1 is applicable to hanging a pair of auxiliary eyeglasses on the spectacles frame.

FIG. 4 is an exploded view of a magnetically mounted connector according to another embodiment of the present invention.

### DETAILED DESCRIPTION OF THE INVENTION

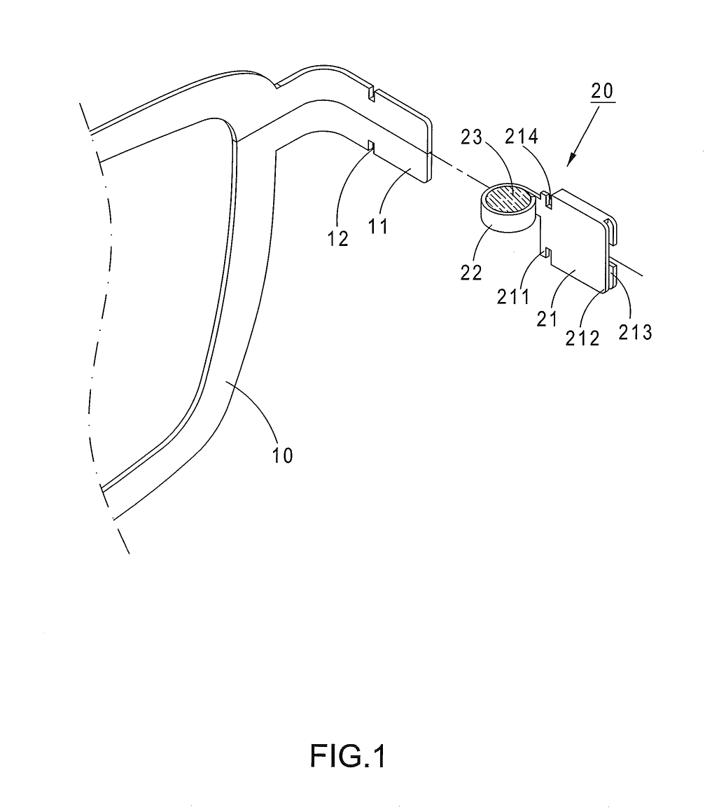

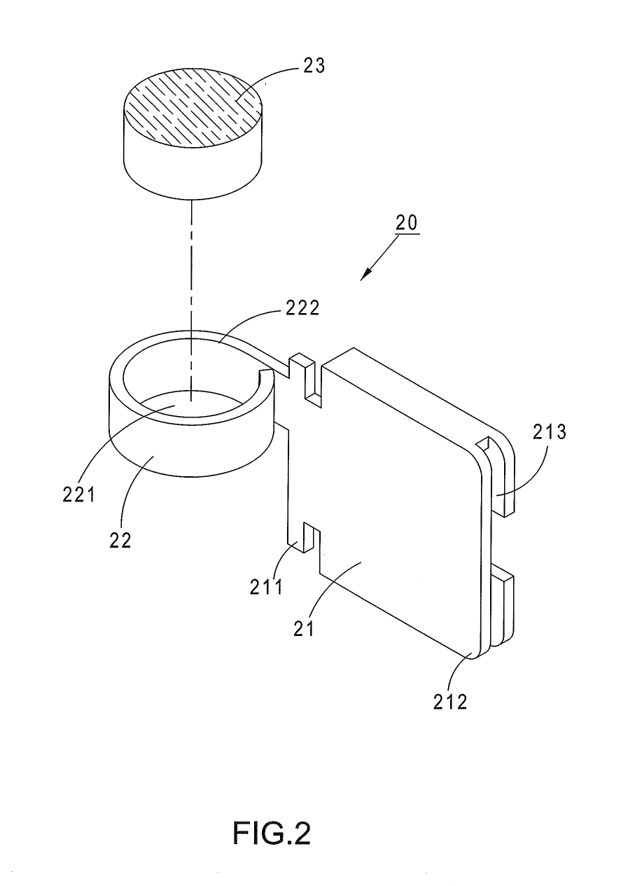

A magnetically mounted connector according to the preferred teachings of the present invention is shown in FIGS. 1 through 3 of the drawings and generally designated 20. The magnetically mounted connector 20 is used to link a spectacles frame 10 and a temple 30 of a pair of eyeglasses. The spectacles frame 10 includes two mounting portions 11 extended outwards at two lateral ends thereof (as shown in FIG. 1 for one of the mounting portions 11 at one lateral end of the spectacles frame 10), and each of the mounting portions 11 has two notches 12 in top and bottom sides thereof, respectively. A front end of each of the temples 30 is provided with a fastening portion 31. In a pair of slim-frame eyeglasses as shown in this embodiment, both the spectacles frame 10 and the temple 30 are made of metal laminates.

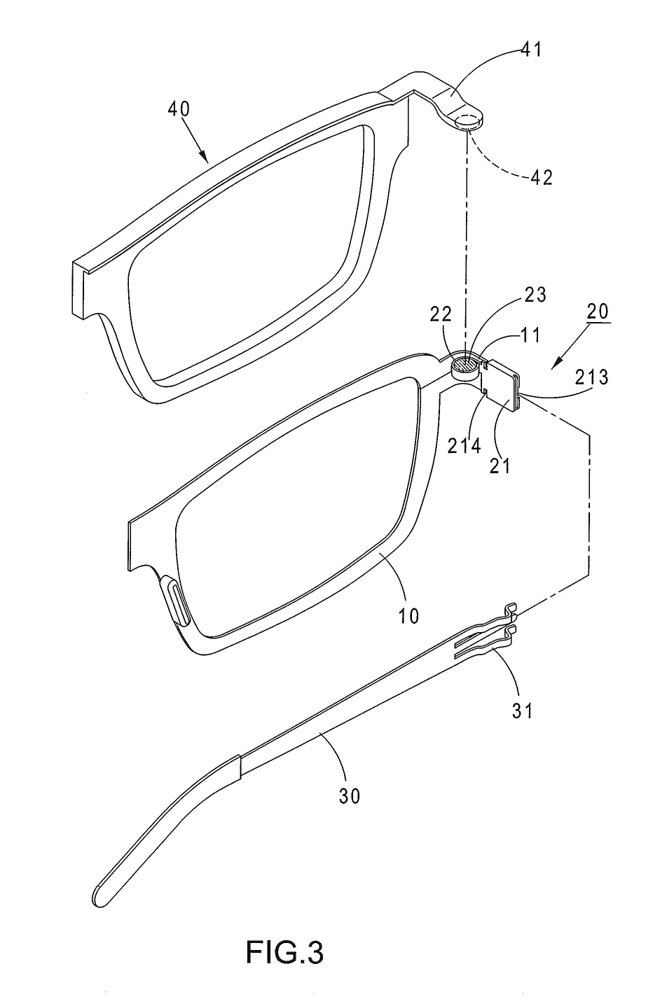

The magnetically mounted connector 20 includes a connector body 21, a magnetic holder 22 and a permanent magnet 23. The connector body 21 may have a distinct structure according to a pair of slim-frame eyeglasses. In this embodiment, the connector body 21 includes a first end 211 and a second end 212 opposed to the first end 211. A clearance slot 213 is formed in the connector body 21 and extended from the first end 211 to the second end 212. The first end 211 of the connector body 21 is adapted to be connected to the mounting portion 11 of the spectacles frame 10. In this embodiment, the mounting portion 11 of the spectacles frame 10 is inserted into the clearance slot 213 from the first end 211 and coupled with the connector body 21. Moreover, the first end 211 has gaps 214 in top and bottom sides thereof, respectively. When the mounting portion 11 of the spectacles frame 10 is inserted into and securely held in the clearance slot 213, the notches 12 in the mounting portion 11 are aligned to the gaps 214, so that the fastening portion 31 of the temple 30 can be fastened in the notches 12 and the gaps 214. In this embodiment, the magnetic holder 22 is extended forward or outward from the first end 211 of the connector body 21 and is in the form of a collar. With the connector body 21 and the mounting portion 11 of the spectacles frame 10 joining together (see FIG. 3), the magnetic holder 22 is situated at an inner side of the mounting portion 11. Furthermore, a cavity 221 is formed in the magnetic holder 22, and an opening 222 is provided in the top of the magnetic holder 22, allowing the magnet 23 to be placed in the cavity 221 from the opening 222 of the magnetic holder 22.

FIG. 3 illustrates a pair of auxiliary eyeglasses 40 adheres to the spectacles frame 10 on which the magnetically mounted connector 20 is installed for constituting a pair of front-hanging eyeglasses. Each lateral end of the pair of auxiliary eyeglass 40 is provided with an extension arm 41 corresponding to the mounting portion 11 as well as the magnetic holder 22 and provided with a magnetically mounted member 42 at a bottom surface thereof. In virtue of magnetic attraction between the magnetically mounted member 42 and the magnet 23, the pair of auxiliary eyeglasses 40 adheres to the front side of the spectacles frame 10 of the pair of slim-frame eyeglasses conveniently.

When the spectacles frame 10 and the temples 30 join together through the magnetically mounted connectors 20, the pair of auxiliary eyeglasses 40 can be hung on the spectacles frame 10 because of the magnets 23 securely fixed in the magnetic holders 22 without falling. Moreover, a magnet malfunctioned can be easily removed with the magnetically mounted connector 20 replaced. In addition, a pair of auxiliary eyeglasses can be hung on a pair of slim-frame eyeglasses in which some conventional connectors are replaced by the magnetically mounted connectors 20.

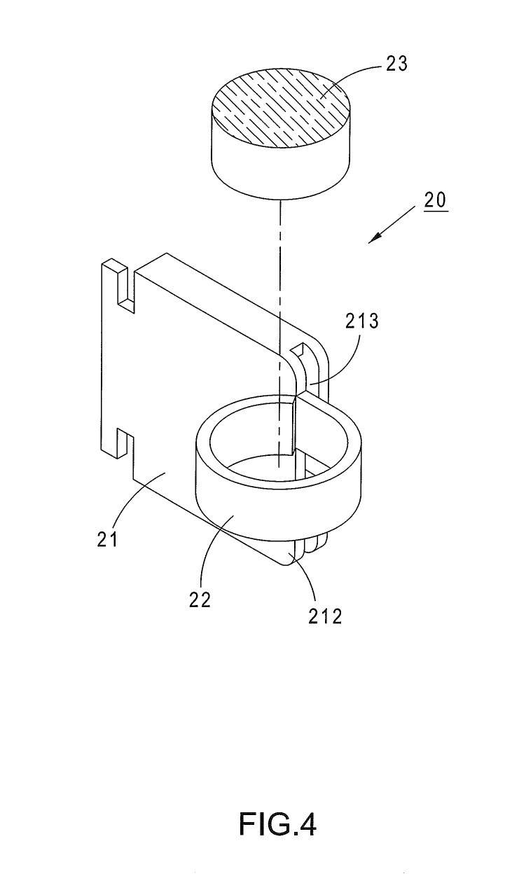

FIG. 4 illustrates a magnetically mounted connector 20 according to a second embodiment of the present invention. In this embodiment, the magnetic holder 22 of the magnetically mounted connector 20 is extended backward or outward from the second end 212 of the connector body 21 and constructed as a circlet component. As such, a pair of auxiliary eyeglasses can be adhered to a spectacles frame of a pair of slim-frame eyeglasses on which the magnetically mounted connector 20 is installed.

The scope of the invention is to be indicated by the appended claims, rather than by the foregoing description, and all changes which come within the meaning and range of equivalency of the claims are intended to be embraced therein.

1. A magnetically mounted connector comprising:
a connector body adapted for joining a spectacles frame and a temple of a pair of eyeglasses, with the spectacles frame having a mounting portion at each of two lateral ends thereof;
a magnetic holder extended outward from the connector body; and
a magnet held in the magnetic holder for combination of a pair of auxiliary eyeglasses to the pair of eyeglasses.

2. The magnetically mounted connector according to claim 1, wherein the magnetic holder is situated at an inner side of the mounting portion of the spectacles frame to which the connector body is connected.

3. The magnetically mounted connector according to claim 1, wherein the connector body includes a first end and a second end opposed to the first end, with the first end of the connector body adapted to be connected to the mounting portion of the spectacles frame, with the magnetic holder extended outward from the first end or the second end of the connector body and being in the form of a collar, with a cavity formed in the magnetic holder, and with an opening provided in a top of the magnetic holder to allow the magnet to be placed in the cavity from the opening of the magnetic holder.

4. The magnetically mounted connector according to claim 2, wherein the connector body includes a first end and a second end opposed to the first end, with the first end of the connector body adapted to be connected to the mounting portion of the spectacles frame, with the magnetic holder extended outward from the first end or the second end of the connector body and being in the form of a collar, with a cavity formed in the magnetic holder, and with an opening provided in a top of the magnetic holder to allow the magnet to be placed in the cavity from the opening of the magnetic holder.
